(19) United States
(12) Patent Application Publication
(10) Pub. No.: US 2025/0320792 A1
(43) Pub. Date: Oct. 16, 2025

(54) HEAT TRANSFER SPOOL FOR INJECTION WELLS

(71) Applicant: Baker Hughes Oilfield Operations LLC, Houston, TX (US)

(72) Inventors: Michael John Blowers, London (GB); Mahmoud Nazerighojogh, Ascot (GB)

(73) Assignee: Baker Hughes Oilfield Operations LLC, Houston, TX (US)

(21) Appl. No.: 19/176,035

(22) Filed: Apr. 10, 2025

Related U.S. Application Data
(60) Provisional application No. 63/632,881, filed on Apr. 11, 2024.

(51) Int. Cl. E21B 41/00; E21B 34/04

(52) U.S. Cl. CPC E21B 41/0064; E21B 34/045

(57) ABSTRACT

A system to be used within carbon capture and sequestration (CCS) and its associated method herein includes at least one mounting structure that may be associated with at least one Christmas tree which is adapted for injection of media which is associated with the CCS into at least one subsea reservoir, where a branch media pipeline may provide the media from the at least one mounting structure to the at least one Christmas tree, and where at least one choke may be in the at least one mounting structure to control a pressure of the media to provide a predetermined and chemical-free response to hydrates formation in a steady state flow of the media prior to the injection of the media into the Christmas tree.

### CROSS-REFERENCE TO RELATED APPLICATION(S)

This Non-Provisional Patent Application is related to and claims the benefit of priority from U.S. Provisional Application No. 63/632,881, titled “HEAT TRANSFER SPOOL FOR INJECTION WELLS,” filed on Apr. 11, 2024, and incorporated by reference herein in its entirety for all intents and purposes.

### BACKGROUND

### 1. Field of Invention

At least one embodiment is related in general to carbon capture and sequestration in offshore operations.

### 2. Description of the Prior Art

Carbon capture and sequestration (CCS) may be used in subsea aspects of offshore operations. Different than oil and gas fields, the subsea aspects may include injecting fluid into subsea wells, now forming reservoirs for carbon capture. However, pipelines that may be part of supplying these subsea wells may be above about 80 bar in pressure, whereas a pressure difference may exist within the subsea well with respect to the pipelines. The pipelines may supply a fluid associated with the CCS operation, such as, a liquid, gas, or liquid-and-gas mixture for injection into the subsea well. Similar to oil and gas fields, the subsea aspects may use a local choke valve on a Christmas tree (also referred to herein as a tree) to moderate a pressure of the fluid before it arrives at the reservoir or subsea well. However, the fluid may be prone to generating hydrates (for example, due to the Joule Thomson effect) in the subsea aspect, similar to oil and gas wells. Chemicals may be used to prevent hydrates in transient flow conditions, but such chemicals are subject to other concerns, including safety, environmental, and expense concerns.

### SUMMARY

In at least one embodiment, a system to be used within carbon capture and sequestration (CCS) is disclosed. The system includes at least one mounting structure associated with at least one Christmas tree that is adapted for injection of media which is associated with the CCS into at least one subsea reservoir. A branch media pipeline is provided, as part of the system, and to support flow of the media from the at least one mounting structure to the at least one Christmas tree. The system includes at least one choke in the at least one mounting structure to control a pressure of the media to provide a predetermined and chemical-free response to hydrates formation in a steady state flow of the media prior to the injection of the media into the Christmas tree.

In at least one embodiment, a method to be used within carbon capture and sequestration (CCS) includes associating at least one mounting structure with the at least one Christmas tree that is adapted for injection of media. The media is associated with the CCS and is for the injection into at least one subsea reservoir. The method includes providing, using a branch media pipeline, the media from the at least one mounting structure to the at least one Christmas tree. The method further includes enabling, using at least one choke in the at least one mounting structure, control of a pressure of the media to provide a predetermined and chemical-free response to hydrates formation in a steady state flow of the media prior to the injection of the media into the Christmas tree.

### BRIEF DESCRIPTION OF THE DRAWINGS

The present technology will be better understood on reading the following detailed description of non-limiting embodiments thereof, and on examining the accompanying drawings, in which:

FIG. 1 illustrates an example system to be used within carbon capture and sequestration, according to aspects of at least one embodiment herein;

FIG. 2 illustrates another example system to be used within carbon capture and sequestration, in accordance with at least one embodiment;

FIG. 3 illustrates yet another example system to be used within carbon capture and sequestration, in accordance with at least one embodiment;

FIG. 4 illustrates a further example system of multiple chokes but with at least one remote choke, to be used within carbon capture and sequestration, according to aspects of at least one embodiment herein;

FIG. 5 illustrates an example system pipe heat-tracing feature to be used within carbon capture and sequestration according to aspects of at least one embodiment herein;

FIG. 6 illustrates a process flow for an example system as described with respect to one or more of FIGS. 1-5, in accordance with at least one embodiment;

FIG. 7 illustrates another process flow for an example system as described with respect to one or more of FIGS. 1-5, in accordance with at least one embodiment; and

FIG. 8 illustrates computer and network aspects for a system to be used with a method and system of FIGS. 1-7, according to at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

In at least one embodiment, a system and method herein address one or more of the aforementioned issues. For example, oil and gas fields may have low-pressure reservoirs as these may be depleted gas fields. A pressure drop may be experience across a choke valve which may be provided on a Christmas tree. The pressure drop causes a corresponding temperature drop. The combination of these drops is associated with potential for hydrate formation in the Christmas Tree, Wellhead, Completion Tubing and Reservoir. One approach to this may be to require hydrate inhibitors, such as methanol, during CCS operations. However, an effect of using methanol is that methanol may promote a drop-out of moisture from a flow stream of a media in the CCS operations. This may be the case where the media includes carbon dioxide (CO₂) but may be also the case with other media. As a flow of media may include CO₂, the drop-out of moisture may result in an acidic liquid being formed and which may promote corrosion of pipelines and associated structures of the well or reservoir.

In injection systems used for CCS herein, a flow may be configured and may be operated to minimize temperature drop due to a Joule-Thompson (JT) effect in a region that is downstream of a choke. For example, such a choke, being located away from a Christmas tree of a reservoir, may be associated with valve operations timed to optimize a flow regime. This can avoid large pressure drops between a pipeline supply and the Christmas tree. The injection system herein is also able to warm the media before entry into the reservoir and is able to do so using the subsea environment. As a result, a hydrate inhibitor may be fully eliminated from or maintained as option in the injection system. Where the chemical injection requirement is removed, a need for chemical lines in an umbilical, as well as other features, such as an infield chemical distribution system, additional valves, and pumping requirement on the facility of land-side structure may be also removed.

Further, while a valve may be used for flow purposes, these valves are to be in an open or closed condition with respect to a flow of media and may take up to 10 seconds to open or close. Differently, a choke may run continuously to adjust a pressure drop. For example, a choke operates longer for a throttle cycle, and can take up to 1 to 3 minutes to adjust for a pressure drop without causing sudden changes that may contribute to hydrate formation. In at least one embodiment, the pressure difference may be between a platform that may be on a land-side structure and a depleted well or reservoir. The choke may be provided (as a variable position valve) on a Christmas tree or manifold that is in a reservoir region to balance the pressure. However, the JT effect may cause cooling and a drop in pressure during balancing of the pressure. This, in turn, may be accompanied by a drop in temperature of the media, which may create crystals. In one example, the crystals may be formed at least minus (−)20 degrees Celsius or less and may include hydrates of inorganic salts and with water molecules present. The water molecules may be in combination, as a ratio, with the inorganic salt in a manner where the crystals can be substantial to block a pipeline. In one example, the crystals may perpetuate into the bottom of the well. As there may be more water downhole in the well or reservoir, formation of crystals downhole may be substantial. This can lead to larger blockages of the well and may need dual completions, downhole chokes, and other complex features to resolve.

In at least one embodiment, approaches herein provide at least one choke in a mounting structure that is away from the tree. This leads to a pressure drop that is moved away from the tree. Therefore, a temperature drop is also moved from the tree. Then, the media to the tree may be subject to warming through the subsea environment that may be warmer than the media. In at least one embodiment, a branch media pipeline may be provided from a main media pipeline or from a mobile structure to carry the media that is subject to warming. The main media pipeline may be from a land-side structure, but the branch media pipeline that is associated with at least one choke is also able to exchange heat with a subsea environment that is for a distance travelled by the branch media pipeline, from the mounting structure to the Christmas tree or a reservoir group. The media, being CO₂ in one example, may be warmed up during its travel time by providing the branch media pipeline as a long heat transfer spool to manage the temperature of the media. As a result, a cold zone or region that is in the tree or a reservoir region associated with the tree is moved away from the tree to a distinct region that may be a predetermined region based in part on modeling using features of the pressure drop, the temperature drop, a subsea environmental temperature, and a distance between the structures, for instance.

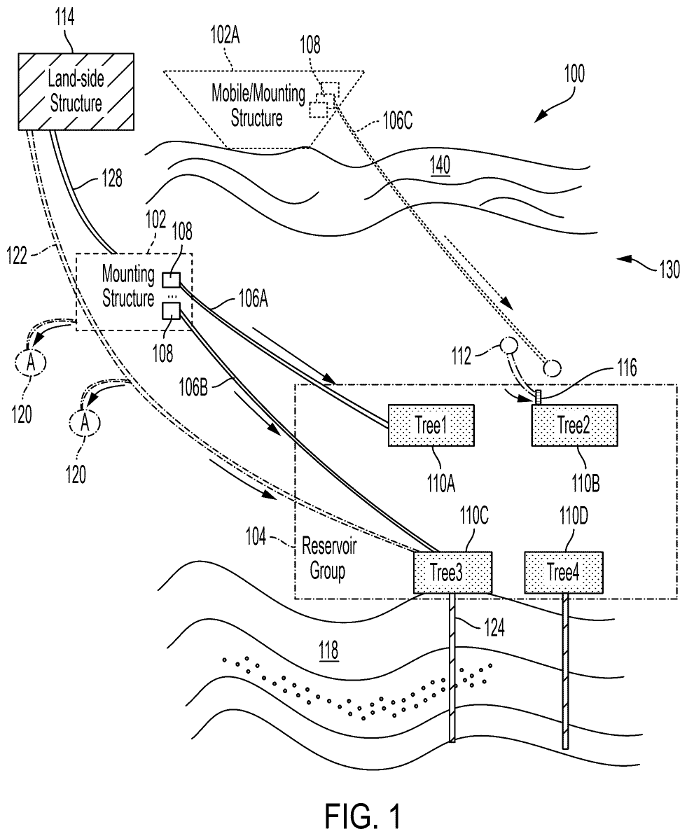

FIG. 1 illustrates an example system 100 to be used within carbon capture and sequestration according to aspects of at least one embodiment herein. A subsea location 130 may be a location that is above a well completion 118 and that extends from a sub-seabed location to a seabed. The well completion 118 may terminate in one or more Christmas trees 110A-D. The one or more Christmas tress 110A-D may form a reservoir group 104 of depleted wells representing a depleted gas field. As such, while four Christmas trees are illustrated in the figure, there may be fewer or more, with each having its own bore representing one depleted well or reservoir 132.

Each Christmas tree (also referred to as tree or Xmas tree) 110A-D may be directly associated with a mounting structure 102; 102A. In one example, a mounting structure 102 may be a subsea structure that is fed from an onshore or land-side structure 114. However, the mounting structure 102 of a mobile structure 102A, such as a ship that has tanks within it and that floats on a surface of the sea 140 instead of being subsea. For example, CO₂ may be provided from the land-side structure 114 into the tanks. The mobile structure 102A can travel to the depleted gas field for injection to one or more Christmas trees. In either implementation, a choke 108 may be provided in the mounting structure 102; 102A that is remote from the Christmas tree 110A-D. There are individual chokes to individual ones of the Christmas trees. This may be to avoid any compensation of pressure across the wells or reservoirs 124. There may be associated injection ports or tie-ins 112, 116 that may be associated directly with each tree to support the injection herein from a branch media pipeline 106A; 106B; 106C, to a respective tree 110A; 110B; 110C; 110D.

Further, the use of the choke 108 in a mounting structure 102; 102A may remove from any need for chemical injection features 120, 122 used for chemical injection. For example, the chemical injection features 120, 122 may be a different pipeline from a land-side structure 114 and may be further tie-ins or ports. These are distinct from the injection of CCS media herein. Therefore, there is no need for multiple such injection ports to support different chemical requirements to address hydrate formation, as readily apparent in the subsequent discussion herein. The injection of CCS media using a remote choke removes or render as optional all such chemical injection ports or tie-ins, fluid blocks, and other features.

One or more such trees 110A-D may receive its media that is initially provided to the mounting structure 102 via main media pipeline 128. Within the mounting structure 102, the main media pipeline may be subject to control of pressure via individual chokes 108 that may be associated with individual branch media pipelines 106A; 106B; 106C. There may be multiple ones of such branch media pipelines 106A; 106B; 106C and each may be associated with its own choke 108 and with a specific tree 110A; 110B; 110C; 110D.

In at least one embodiment, at least one mounting structure 102 is a Pipeline Inline-Tee (PILT), a Pipeline End Termination (PLET), a Pipeline End Manifold (PLEM), an intermediate subsea block, or an intermediate subsea manifold. In all such implementations, the mounting structure 102 is necessarily in a distinct and likely a predetermined region, away from a reservoir region 130 having the trees 110A-D or with respect to the trees 110A-D. The mounting structure 102 may be, therefore, between the Christmas trees 110A-D and a main media pipeline 128 that is from a land-side structure. However, in at least one embodiment, the mounting structure is solely coupled to the Christmas trees 110A-D via a branch media pipeline 106C and using individual chokes 108 for each tree.

In at least one embodiment, the mounting structure 102 may be associated with flow pipes 128, 106A-D, that may be sometimes referred to or included within risers, jumpers, an umbilical, or other flexible pipe systems. While such flow pipes can transport production and service fluids, but can also transfer other fluids, such as, intervention fluid, the main media pipeline and the branch media pipelines herein are associated with a CCS operation alone and can support mixed media of liquid, gas, and fluids to be injected into a well or reservoir 124.

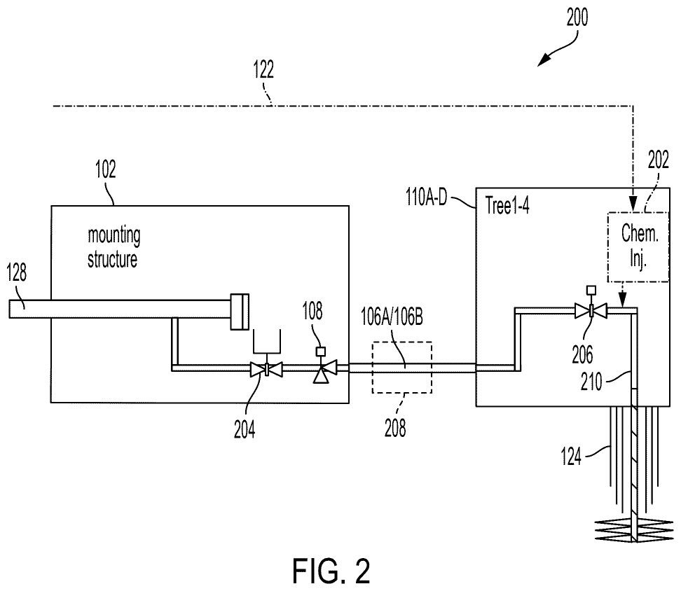

FIG. 2 illustrates another example system 200 to be used within carbon capture and sequestration, in accordance with at least one embodiment. The system 200 of FIG. 2 may be implemented in aspects of the system 100 of FIG. 1. The system 200 of FIG. 2 may include at least one mounting structure 102 that may be associated with at least one Christmas tree 110A-D. The Christmas tree is adapted for injection of media which is associated with the CCS into at least one subsea reservoir. Further, as illustrated in FIG. 2, a branch media pipeline 106A, 106B may be provided from a main media pipeline 128 for the media. Alternatively, the branch media pipeline 106C may be provided from a mobile mounting structure 102A for one or more chokes 108 that is remote from the tree 110A-D. The branch media pipeline 106A; 106B may provide the media from the at least one mounting structure 102 to the at least one Christmas tree 110A-D.

FIG. 2 also illustrates that there is at least one choke 108 in the at least one mounting structure 102. The at least one choke 108 can be used to control a pressure of the media through the branch media pipeline 106A; 106B to provide a predetermined and chemical-free response to hydrates formation in a steady state flow of the media prior to the injection of the media into the Christmas media. For example, a predetermined and chemical-free response may include one of maintaining a temperature for the media at higher than −20 degree centigrade (C) in the steady state flow; maintaining the steady state flow within the branch media pipeline for a predetermined period to enable warming by subsea environment; or enabling the steady state flow to be substantially within the branch media pipeline which comprises a wall thickness in a range of a ½ inch to 3 inch. FIG. 2 also illustrates that, as a result of the system herein, the chemical pipeline 122 and injection feature 202 can be removed.

The effect of the predetermined and chemical-free response is to ensure that any hydrates in a formation zone remain unattached to walls of the branch media pipe line, prior to the injection of the media into the Christmas tree. In at least one embodiment, the mounting structure 102; 102A may include a block, a manifold, an ILT, a PLET, a PLEM, or any intermediate structure that can host a choke 108 and that is between at least one CO₂ source (such as a land-side structure 114 or a tank of a mobile structure) and the tree. The choke 108 is, therefore, mounted to the mounting structure 102 as a remote choke that is away from the tree or systems in a reservoir region having the tree.

In at least one embodiment, the choke 108 is a remotely located choke that is provided in combination with a suitable length of the branch media pipeline 106A; 106B; 106C. In one example, the suitable length may be between 50 meters and 100 meters, between 100 meters and 150 meters, or between 50 meters and 500 meters. Still further, the suitable length may be measured from and outside of the mounting structure 102 to an outside of the tree or a tie-in or port of a tree. The suitable length may be determined in part by modeling of the temperature drop that may occur, the pressure drop to be addressed, and the subsea temperature. In one example, the branch media pipeline 106A; 106B; 106C includes a wall thickness of between ½ inch to 3 inches. This wall thickness is less than a thickness of a block of a tree 110A-D. This wall thickness of this range, relative to a wall thickness of a block of the tree, allows for the subsea environment to warm the CSS media and to prevent hydrates from associating or sticking to the walls, which may lead to build up of hydrates.

Further, this represents one predetermined and chemical-free response to hydrates formation in a steady state flow of the media prior to the injection of the media into the Christmas tree. In another example of a predetermined and chemical-free response to hydrates formation in a steady state flow, the branch media pipeline 106A; 106B; 106C may be enabled to maintain a temperature for the media at higher than −20 degree centigrade (C) in the steady state flow. This may be possible by correlating at least a wall thickness and/or a temperature of a subsea environment with a pressure needed to maintain the steady state flow within the branch media pipeline for a predetermined period. Therefore, the steady state flow can be enabled to be substantially within the branch media pipeline which comprises a wall thickness in a range of a ½ inch to 3 inch. These features can enable warming of the CSS media by the subsea environment, as part of a predetermined and chemical-free response to hydrates formation.

In at least one embodiment, all such features may be used to determine a pressure at which to deliver the media using the choke so as to keep the media warm and to keep the media in a zone 208 of the branch media pipeline 106A-106C which is outside a hydrate formation zone 210, prior to injection into a Christmas tree. The branch media pipeline 106A; 106B may be also referred to herein as branch well jumper.

The branch media pipeline 106A; 106B enables a system 200 that is able to move a cold zone or region 210 away from a reservoir region 118 that has the depleted wells or low-pressure aquifer reservoirs. In one example, a cold zone may be a zone or region 210 that is at risk of hydrates formation during a CCS operation. In at least one embodiment, the system 200 herein can address hydrates formation in choke-on-tree related configurations. However, the choke-on-tree related configurations may still lead to a risk of hydrate formation in the well, as well as in near-well reservoir regions, which may be approximately up to 100 meters from at least one bore 132. The cold zone or region 210 may be moved upstream, to a distinct region 208, in which heat from a subsea environment may warm the media. In at least one embodiment, the distinct region 208 may be predetermined region that is distinct from reservoir region 210 and may be based in part on a predetermined length available in the system 200, as well as based in part on a temperature associated with a pressure enabled by the at least one choke 108.

In at least one embodiment, the choke 108 may be provided in series or in other association with a valve 204 that is also in the mounting structure 102. However, a further valve 206 may be provided locally in the tree to enable local control of the media. Either of such valves 204; 206 is, however, distinct from a choke, and may be a solenoid, pneumatic, motorized, or other powered valve that operates to provide or prevent a flow of the media. In one example, subsequent to the valve 204, the choke 108 is provided to address, in part, remote requirements of at least one tree. Therefore, the choke 108 can be provided to address any pressure drop requirements, even caused in part by a pressure from one or more of the valves 204, 206, to prevent crystal formation at the tree or during a CCS injection operation of associated media. FIG. 2 also illustrates that the remote choke 108 may eliminate the need for a chemical injection 202 feature but that such an option may exist in at least one embodiment.

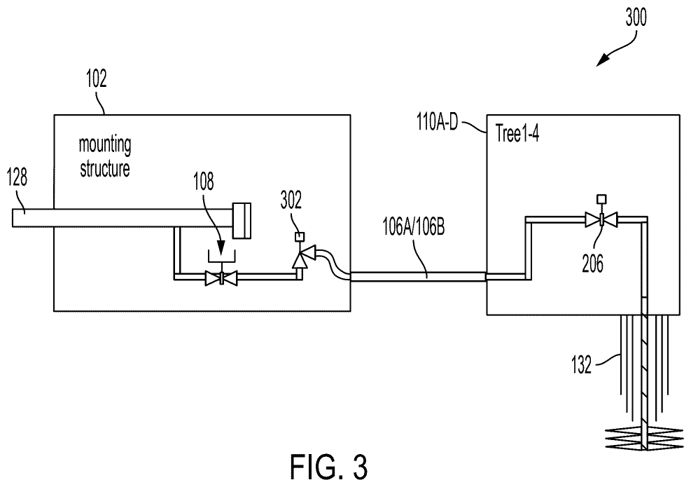

FIG. 3 illustrates another example system 300 to be used within carbon capture and sequestration, in accordance with at least one embodiment. The system 300 removes the chemical injection 202 feature so that at least one mounting structure 102 may be associated with at least one Christmas tree 110A-D (or in the reservoir group 104) that is adapted for injection of media, from a CCS operation, into at least one subsea reservoir. The system 300 includes a branch media pipeline 106A; 106B from a main media pipeline 128. The branch media pipeline 106A; 106B; 106C can provide the media from the at least one mounting structure 102; 102A to the at least one Christmas tree. The at least one choke 108 in the at least one mounting structure 102; 102A can control a pressure of the media to ensure a predetermined and chemical-free response to hydrates formation in a steady state flow of the media prior to the injection of the media into the Christmas tree. However, there may be further a further valve 204, which is different than the choke 108, to provide opening and closing of the media, while the choke 108 can provide the required controls. Therefore, the predetermined and chemical-free may be ensured till at least a subsequent local valve 206 of the Christmas tree is reached but may preferentially extend beyond the local valve.

Further, in each of the FIGS. herein, the branch media pipeline 106A; 106B may be submerged in sea water that is associated with the at least one subsea reservoir 132 to further enable at least one of the predetermined and chemical-free response to hydrates formation in a steady state flow of the media. The system 300 may be also subject to a valve opening and closing sequence, as part of the predetermined and chemical-free response to hydrates formation in a steady state flow of the media. For example, a determination may be made about threshold pressure differences between the at least one choke 108, prior to ceasing of a flow associated with the media through the branch media pipeline 106A; 106B or together starting up the at least one subsea reservoir 132. The threshold pressure differences may be a range that is such that hydrate formation does not occur during shutdown or startup. The determination about the threshold pressure differences may be also based at least in part on a system modelled and subject to a subsea injection system. For example, a system may be modelled according to temperatures in the subsea environment, pressures in at least one reservoir 132 and in the main media pipeline 128, and a length of the branch media pipeline 106A; 106B to the at least one reservoir 132. Such modeling and application to the system represents at least one predetermined and chemical-free response to hydrates formation in a steady state flow of the media.

In at least one embodiment, the system may be modelled using machine learning, including machine learning using temperatures, pressures, and lengths (or distances) associated with the system 100-500 herein. The temperatures, pressures, and lengths may be features of a machine learning model, which may be trained to classify two or more of these features to predict or allow inference of a pressure to be adjusted or a distance to be maintained, through a period of time for the choke to support the media being maintained outside the hydrate formation zone. In at least one embodiment, the valve opening and closing sequence may be then provided, based on the outcome of the machine learning model, in an automation sequence to ensure threshold pressure differences in the system. In one example, the threshold pressure differences may be prior to ceasing of a flow associated with the media through the branch media pipeline or together with starting up the at least one reservoir for purposes of the CCS operations herein.

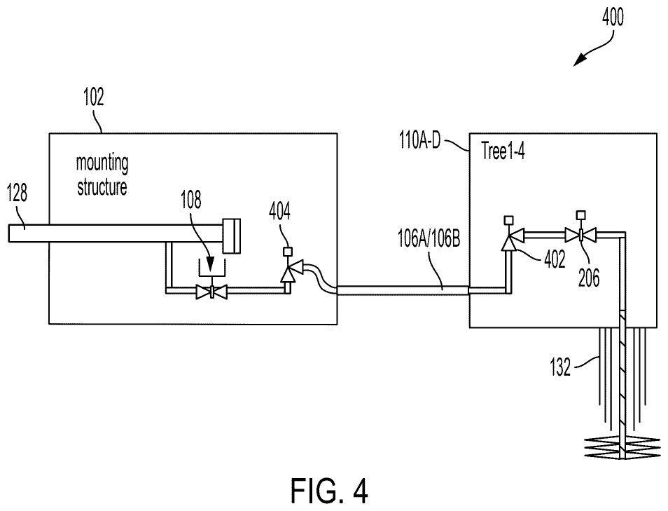

FIG. 4 illustrates a further example system 400 of multiple chokes but with at least one remote choke, to be used within carbon capture and sequestration, according to aspects of at least one embodiment herein. The system 400 illustrates that the at least one choke 108 may include two or more chokes. However, at least one of the two or more chokes is a remote choke 108. The chokes may be in series or parallel to create multi-stage pressure drops to mitigate low temperatures by minimizing pressure each drop. In at least one embodiment, a determination may be made as to a requirement associated with an injection pressure at the Christmas tree. Then, the multi-stage pressure drop may be enabled depending, in part, on a length or distance to be travelled by the media. The multi-stage pressure drop may be controlled in part using a control system that triggers the at least one choke so that the pressure of the media may be based in part on the requirement associated with the injection pressure of each well or reservoir.

In one example, the controlling for the injection pressure may be performed using the at least a local choke 402 at the Christmas tree, where the injection pressure is different than the control of the pressure of the media using the at least one remote choke 404 of the at least one mounting structure to provide a predetermined and chemical-free response to hydrates formation in a steady state flow of the media, prior to the injection of the media into the Christmas tree. In at least one embodiment, because the branch media pipeline 106A; 106B is a spool or a jumper that allows for good heat transfer to the internal fluids, the branch media pipeline 106A; 106B may be provided from a rigid metal or flexible materials.

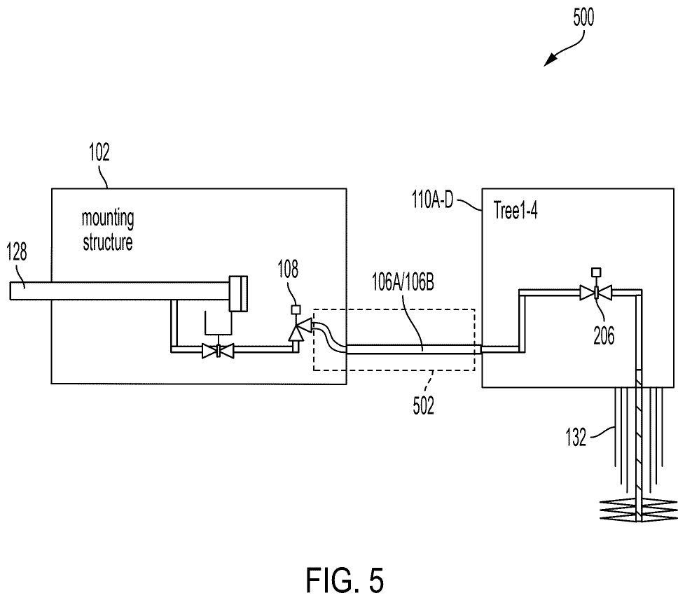

FIG. 5 illustrates an example system 500 with a pipe trace-heating feature to be used within carbon capture and sequestration according to aspects of at least one embodiment herein. Like in the description of FIGS. 1-4, the system 500 of FIG. 5 may include at least one mounting structure associated with at least one Christmas tree that is adapted for injection of media which is associated with the CCS into at least one subsea reservoir. A branch media pipeline 106A; 106B is provided from a main media pipeline 128 and has an associated choke 108 for providing a predetermined and chemical-free response to hydrates formation in a steady state flow of the media prior to the injection of the media into the Christmas tree. The branch media pipeline 106A; 106B that provides the media from the at least one mounting structure to the at least one Christmas tree may be further supported by a pipe trace-heating feature 502. The pipe trace-heating feature 502 can further warm the media beyond what is possible just from the subsea environment. The pipe trace-heating feature 502 may also remain in idle but may also be used in the event of hydrate forming in the branch media pipeline as it can speed up a rate of hydrate being dissolved. The pipe trace-heating feature 502 can also enable any of the systems 300-500 to function without the chemical injection.

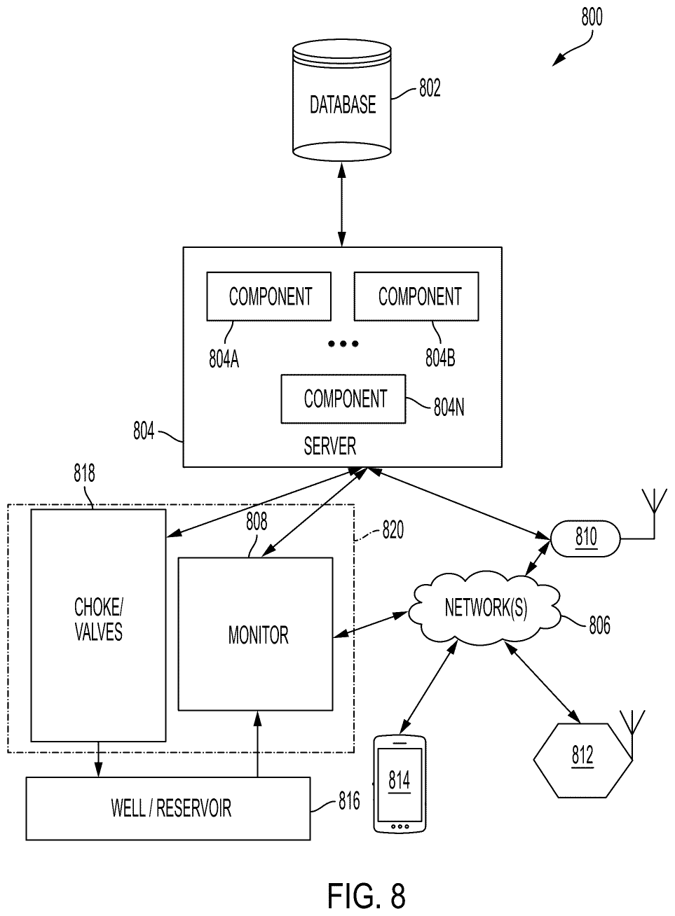

Therefore, altogether with the at least one choke in the at least one mounting structure to control a pressure of the media, it is possible to provide a predetermined and chemical-free response to hydrates formation in a steady state flow of the media prior to the injection of the media into the Christmas tree. The trace-heating feature 502 can further enable the predetermined and chemical-free response to hydrates formation in a steady state flow of the media prior to the injection of the media into the Christmas tree of the media. For example, the pipe trace-heating is at a temperature that is higher relative to a subsea environment and provides heating to the media, through the walls of the branch media pipeline. The system 500 using the valve opening and/or closing sequence can optimize pressure differences therein, prior to the ceasing flow or starting up the well for CCS operations. The subsea injection system may be provided based in part on system modeling, as described further with respect to the computer aspects in FIG. 8. Software may be built into the subsea injection system using provided interfaces to control one or more of the chokes or valves of the systems 100-500 herein to enable the valve opening and/or closing sequences herein.

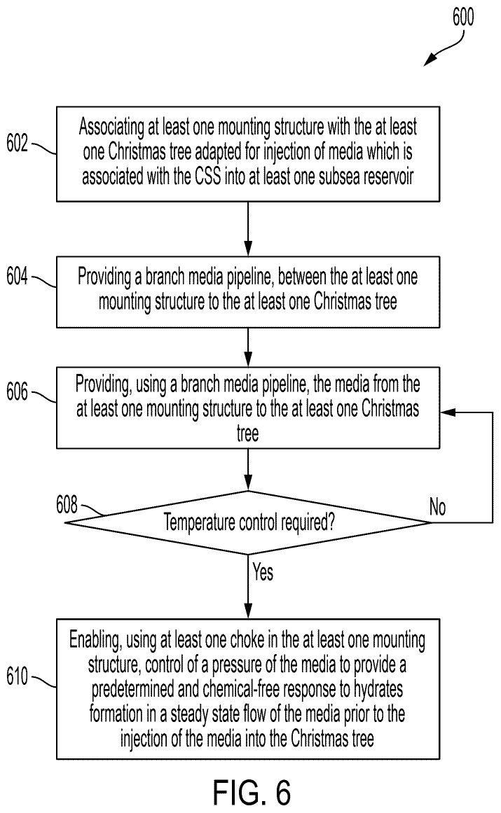

FIG. 6 illustrates a process flow or method 600 for an example system as described with respect to one or more of FIGS. 1-5, in accordance with at least one embodiment. The method 600 may include associating 602 at least one mounting structure with the at least one Christmas tree. The association may be performed, in part, by a modeling to determine a layout and distances, pressures, and temperatures associated with the subsea environment, the pipelines 128, 106A; 106B, and the well 132 to be subject to CCS operations. The Christmas tree is adapted for injection of media into at least one subsea reservoir and the media is associated with the CCS operations. The method 600 may include providing 604 a branch media pipeline, from a main media pipeline, between at least one mounting structure and the Christmas tree. The method 600 may include providing 606, using the branch media pipeline, the media from the at least one mounting structure to the at least one Christmas tree.

The method 600 may include verifying 608 that a temperature control is required. For example, the verifying 608 step may be performed using a monitoring module for monitoring crystal formation, for monitoring temperatures within the branch media pipeline, or for monitoring a pressure difference from a mounting structure subsea main media pipeline to a Christmas tree side of the branch media pipeline. The monitored information may be used to determine to provide control or adjustment to the media. For example, while machine learning may be used to determine initial sequences for the choke and valves, the machine learning model herein may be used to provide updated information of at least pressure requirements based in part on the monitored information. The method 600 may include enabling 610, using at least one choke in the at least one mounting structure, control of a pressure of the media to provide a predetermined and chemical-free response to hydrates formation in a steady state flow of the media prior to the injection of the media into the Christmas tree.

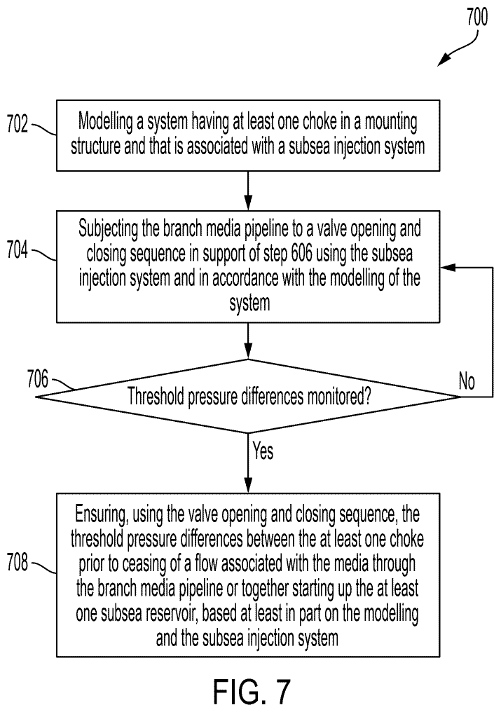

FIG. 7 illustrates another process flow or method 700 for an example system as described with respect to one or more of FIGS. 1-5, in accordance with at least one embodiment. The method 700 of FIG. 7 may be used with the method 600 of FIG. 6. The method 700 in FIG. 7 may include modeling 702 a system having at least one choke in a mounting structure and that is associated with a subsea injection system. The method 700 may also include subjecting 704 the branch media pipeline to an opening and a closing sequence in support of step 606 of the method 600 in FIG. 6. For example, the modeling 702 of the system having the at least one choke in a mounting structure may provide pressure, temperature, and other aspects in simulation that may be implemented in a physical version of the subsea injection system.

For example, the modeling 702 may include using machine learning. For example, a machine learning model may be generated using temperatures, pressures, and lengths (or distances) associated with the system 100-500 herein. The temperatures, pressures, and lengths may be features of a machine learning model, which may be trained to classify two or more of these features to predict or allow inference of a pressure to be adjusted or a distance to be maintained, through a period of time for the choke to support a predetermined and chemical-free response to hydrates formation in a steady state flow of the media prior to the injection of the media into the Christmas tree. In at least one embodiment, the valve opening and closing sequence may be then provided, based on the outcome of the machine learning model, in an automation sequence to ensure threshold pressure differences in the system. In one example, the threshold pressure differences may be prior to ceasing of a flow associated with the media through the branch media pipeline or together with starting up the at least one reservoir for purposes of the CCS operations herein.

The method 700 may include verifying 706 that threshold pressure differences are being monitored. For example, based in part on the modeling and an intent to maintain pressure differences to a suitable degree to prevent temperature fall off that may contribute to crystal formation, the verification 706 may be set in place for intended pressure differences forming the threshold pressure differences. Then, the method 700 may include ensuring 708, using the valve opening and closing sequence, the threshold pressure differences between the at least one choke prior to ceasing of a flow associated with the media through the branch media pipeline or together starting up the at least one subsea reservoir. This is based at least in part on the modeling and the subsea injection system so that the pressure differences may be kept within the threshold pressure differences.

The method of FIGS. 6 and 7 herein may be such that the at least one mounting structure is a Pipeline Inline-Tee (ILT), a Pipeline End Termination (PLET), a Pipeline End Manifold (PLEM), a subsea block, a mobile structure, or an intermediate subsea manifold. The mounting structure may be between the main media pipeline from a land-side structure and the Christmas tree. The methods of FIGS. 6 and 7 herein may include a further step or sub-step for determining a predetermined length for the branch media pipeline based at least in part on a temperature associated with the pressure enabled by the at least one choke. Then, using the predetermined length of the branch media pipeline, a cold zone may be moved from a reservoir region associated with the at least one subsea reservoir to at least a predetermined region (that may be close to the mounting structure) that is distinct from reservoir region. This may be enabled in part by the subsea injection system using the opening and closing sequences for the choke and the valves.

The methods of FIGS. 6 and 7 herein may include a further step or sub-step for determining, in addition to the media being outside the hydrate formation conditions, a requirement associated with an injection pressure at the Christmas tree. The methods herein may include controlling, using the at least one choke, the pressure of the media based in part on the requirement associated with the injection pressure. This requirement may be different than the pressure associated with the predetermined and chemical-free response to hydrates formation in a steady state flow of the media. Therefore, the methods of FIGS. 6 and 7 herein may include a further step or sub-step for controlling, using the at least a local choke at the Christmas tree, an injection pressure that is different than the control of the pressure of the media to provide a predetermined and chemical-free response to hydrates formation in a steady state flow of the media prior to the injection of the media into the Christmas tree.

Further, the methods of FIGS. 6 and 7 herein may be such that the branch media pipeline is between 50 meters and 100 meters, between 100 meters and 150 meters, or between 50 meters and 500 meters in length. The methods of FIGS. 6 and 7 herein may be such that the at least one choke is a series connection or a parallel connection of at least two chokes. Then, the at least one of the at least two chokes is in the at least one mounting structure and a second one of the at least two chokes may be mounted on the Christmas tree.

Further, the methods of FIGS. 6 and 7 herein may be such that the branch media pipeline is a heat exchanger to allow transfer of heat from the subsea environment to the media. For example, the metal of the branch media pipeline allows for heat exchange from a subsea environment to the media, reflecting at least one predetermined and chemical-free response to hydrates formation in a steady state flow of the media prior to the injection of the media into the Christmas tree. For example, one or more of maintaining a temperature for the media at higher than −20 degree centigrade (C) in the steady state flow, maintaining the steady state flow within the branch media pipeline for a predetermined period to enable warming by subsea environment, or enabling the steady state flow to be substantially within the branch media pipeline which has a wall thickness in a range of a ½ inch to 3 inch, may be a predetermined response.

Further, the predetermined response ensures that the hydrate formation conditions or phase for the CCS operations is addressed. While hydrates may continue to form, the hydrates do not adhere to a wall of the branch media pipeline as a result of the predetermined responses. This prevents build-up of hydrates and allows the hydrates to flow substantially freely through the branch media pipeline. The methods of FIGS. 6 and 7 herein may include a further step or sub-step for enabling further, using pipe trace-heating, the predetermined response for the media. The pipe trace-heating may be at a temperature that is higher relative to a subsea environment.

FIG. 8 illustrates computer and network aspects 800 for a system and method as illustrated and discussed with respect to FIGS. 1-7 herein. In at least one embodiment, these computer and network aspects 800 may include a distributed system. In at least one embodiment, a distributed system 800 may include one or more computing devices 812, 814. In at least one embodiment, one or more computing devices 812, 814 may be adapted to execute and function with a client application, such as with browsers or a stand-alone application, and are adapted to execute and function over one or more network(s) 806.

In at least one embodiment, a server 804, having components 804A-N may be communicatively coupled with computing devices 812, 814 via a network 806 and via a monitor device 808, if provided. In at least one embodiment, components 804A-N include processors, memory and random-access memory (RAM). In at least one embodiment, a server 804 may be adapted to operate services or applications to manage functions and sessions associated with database access 802 and associated with computing devices 812, 814. In at least one embodiment, a server 804 may be associated with a monitor device 808 of a subsea injection system 820.

In at least one embodiment, server 804 may be at a well or reservoir, but may also be at a distinct location from a wellsite location. In at least one embodiment, such a server 804 may support or be part of a subsea injection system 820. Therefore, the boundaries illustrated in FIG. 8 may be moved as the subsea injection system 820 may include processing aspects and memory aspects from the server 804. A choke or other valves 818 receives signals for performing an open or close sequence for a well or reservoir 816.

In at least one embodiment, a server 804 may also provide services or applications that are software-based in a virtual or a physical environment. Such a server may include a machine learning model that is trained based in part on provided features to provide an inference or prediction to a pressure and sequence to be associated with at least a valve and a choke of a mounting structure. In at least one embodiment, when server 804 is a virtual environment, then components 804A-N are software components that may be implemented on a cloud. In at least one embodiment, this feature allows remote operation of a system for CCS operations, as discussed at least in reference to FIGS. 1-7. In at least one embodiment, this feature also allows for remote access to information received and communicated between any of aforementioned devices. In at least one embodiment, one or more components 804A-N of a server 804 may be implemented in hardware or firmware, other than a software implementation described throughout herein. In at least one embodiment, combinations thereof may also be used.

In at least one embodiment, one computing device 810-814 may be a smart monitor or a display having at least a microcontroller and memory having instructions to enable display of information monitored by a detector or receiver device. In at least one embodiment, one computing device 810-812 may be a transmitter device to transmit directly to a receiver device or to transmit via a network 806 to a monitor device 808 and to a server 804, as well as to other computing devices 812, 814.

In at least one embodiment, other computing devices 812, 814 may include portable handheld devices that are not limited to smartphones, cellular telephones, tablet computers, personal digital assistants (PDAs), and wearable devices (head mounted displays, watches, etc.). In at least one embodiment, other computing devices 812, 814 may operate one or more operating systems including Microsoft Windows Mobile®, Windows® (of any generation), and/or a variety of mobile operating systems such as iOS®, Windows Phone®, Android®, BlackBerry®, Palm OS®, and/or variations thereof.

In at least one embodiment, other computing devices 812, 814 may support applications designed as internet-related applications, electronic mail (email), short or multimedia message service (SMS or MMS) applications and may use other communication protocols. In at least one embodiment, other computing devices 812, 814 may also include general purpose personal computers and/or laptop computers running such operating systems as Microsoft Windows®, Apple Macintosh®, and/or Linux®. In at least one embodiment, other computing devices 812, 814 may be workstations running UNIX® or UNIX-like operating systems or other GNU/Linux operating systems, such as Google Chrome OS®. In at least one embodiment, thin-client devices, including gaming systems (Microsoft Xbox®) may be used as other computing device 812, 814.

In at least one embodiment, network(s) 806 may be any type of network that can support data communications using various protocols, including TCP/IP (transmission control protocol/Internet protocol), SNA (systems network architecture), IPX (Internet packet exchange), AppleTalk®, and/or variations thereof. In at least one embodiment, network(s) 506 may be a networks that is based on Ethernet, Token-Ring, a wide-area network, Internet, a virtual network, a virtual private network (VPN), a local area network (LAN), an intranet, an extranet, a public switched telephone network (PSTN), an infra-red network, a wireless network (such as that operating with guidelines from an institution like the Institute of Electrical and Electronics (IEEE) 802.11 suite of protocols, Bluetooth®, and/or any other wireless protocol), and/or any combination of these and/or other networks. In at least one embodiment, the system 800 may include Process Logic Controllers (PLCs) as part of one or more of the server or the subsea injection system 820. In one example, a PLC may be one that is provided by GE®, Rockwell®, or other providers of PLCs, as would be readily appreciated using the descriptions herein.

In at least one embodiment, a server 804 runs a suitable operating system, including any of operating systems described throughout herein. In at least one embodiment, server 504 may also run some server applications, including HTTP (hypertext transport protocol) servers, FTP (file transfer protocol) servers, CGI (common gateway interface) servers, JAVA® servers, database servers, and/or variations thereof. In at least one embodiment, a database 802 is supported by database server feature of a server 804 provided with front-end capabilities. In at least one embodiment, such database server features include those available from Oracle®, Microsoft®, Sybase®, IBM® (International Business Machines), and/or variations thereof.

In at least one embodiment, a server 804 is able to provide feeds and/or real-time updates for media feeds. In at least one embodiment, a server 804 is part of multiple server boxes spread over an area, but functioning for a presently described process for neural networks or machine learning in CCS operations. In at least one embodiment, server 804 includes applications to measure network performance by network monitoring and traffic management. In at least one embodiment, a provided database 802 enables information storage from a wellsite, including user interactions, usage patterns information, adaptation rules information, and other information.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A system to be used within carbon capture and sequestration (CCS), the system comprising:
at least one mounting structure associated with at least one Christmas tree adapted for injection of media which is associated with the CCS into at least one subsea reservoir;
a branch media pipeline to provide the media from the at least one mounting structure to the at least one Christmas tree; and
at least one choke in the at least one mounting structure to control a pressure of the media to provide a predetermined and chemical-free response to hydrates formation in a steady state flow of the media prior to the injection of the media into the Christmas tree.

2. The system of claim 1, wherein the predetermined and chemical-free response is one of:
maintaining a temperature for the media at higher than −20 degree centigrade (C) in the steady state flow;
maintaining the steady state flow within the branch media pipeline for a predetermined period to enable warming by subsea environment;
maintaining a predetermined length for the steady state flow within the branch media pipeline; or enabling the steady state flow to be substantially within the branch media pipeline which comprises a wall thickness in a range of a ½ inch to 3 inch.

3. The system of claim 1, wherein the at least one mounting structure is a Pipeline Inline-Tee (ILT), a Pipeline End Termination (PLET), a Pipeline End Manifold (PLEM), a subsea block, a mobile structure, or an intermediate subsea manifold, which is between a main media pipeline from a land-side structure or a mobile structure and the Christmas tree.

4. The system of claim 1, further comprising:
a predetermined length of the branch media pipeline to move a cold zone from a reservoir region associated with the at least one subsea reservoir to at least a predetermined region that is distinct from reservoir region, the predetermined length based in part on a temperature associated with the pressure enabled by the at least one choke.

5. The system of claim 1, wherein the at least one choke is to control the pressure also based in part on a requirement associated with an injection pressure at the Christmas tree.

6. The system of claim 1, further comprising
at least a local choke at the Christmas tree to a provide control of an injection pressure that is different than the control of the pressure of the media for the predetermined and chemical-free response, using the at least one choke of the at least one mounting structure.

7. The system of claim 1, wherein the branch media pipeline is between 50 meters and 100 meters, between 100 meters and 150 meters, or between 50 meters and 500 meters in length.

8. The system of claim 1, wherein the branch media pipeline is submerged in sea water associated with the at least one subsea reservoir to further support the predetermined and chemical-free response to the hydrates formation, wherein the system is subject to a valve opening and closing sequence, the valve opening and closing sequence to ensure threshold pressure differences in the system prior to ceasing of a flow associated with the media through the branch media pipeline or together with starting up the at least one reservoir.

9. The system of claim 1, wherein the at least one choke is a series connection or a parallel connection of at least two chokes, wherein at least one of the at least two chokes is in the at least one mounting structure.

10. The system of claim 1, wherein the branch media pipeline is a heat exchanger to allow transfer of heat from a subsea environment to the media.

11. The system of claim 1, further comprising:
pipe trace-heating to further enable the predetermined and chemical-free response to the hydrates formation in the media, the pipe trace-heating to be at a temperature that is higher relative to a subsea environment.

12. A method to be used within carbon capture and sequestration (CCS), the method comprising:
associating at least one mounting structure with at least one Christmas tree adapted for injection of media which is associated with the CCS into at least one subsea reservoir;
providing, using a branch media pipeline, the media from the at least one mounting structure to at least one Christmas tree; and
enabling, using at least one choke in the at least one mounting structure, control of a pressure of the media to provide a predetermined and chemical-free response to hydrates formation in a steady state flow of the media prior to the injection of the media into the Christmas tree.

13. The method of claim 12, wherein the at least one mounting structure is a Pipeline Inline-Tee (ILT), a Pipeline End Termination (PLET), a Pipeline End Manifold (PLEM), a subsea block, a mobile structure, or an intermediate subsea manifold, which is between a main media pipeline from a land-side structure or mobile structure and the Christmas tree.

14. The method of claim 12, further comprising:
determining a predetermined length for the branch media pipeline based at least in part on a temperature associated with the pressure enabled by the at least one choke; and
moving, using the predetermined length of the branch media pipeline, a cold zone from a reservoir region associated with the at least one subsea reservoir to at least a predetermined region that is distinct from reservoir region.

15. The method of claim 12, further comprising:
determining, in addition to the predetermined and chemical-free response, a requirement associated with an injection pressure at the Christmas tree; and
controlling, using the at least one choke, the pressure of the media based in part on the requirement associated with the injection pressure.

16. The method of claim 12, further comprising:
controlling, using the at least a local choke at the Christmas tree, an injection pressure into the Christmas tree, the injection pressure being different than the control of the pressure of the media to provide the predetermined and chemical-free response.

17. The method of claim 12, wherein the predetermined and chemical-free response is one of:
maintaining a temperature for the media at higher than −20 degree centigrade (C) in the steady state flow;
maintaining the steady state flow within the branch media pipeline for a predetermined period to enable warming by subsea environment;
maintaining a predetermined length for the steady state flow within the branch media pipeline; or
enabling the steady state flow to be substantially within the branch media pipeline which comprises a wall thickness in a range of a ½ inch to 3 inch.

18. The method of claim 12, wherein the branch media pipeline is submerged in sea water associated with the at least one subsea reservoir to further support the predetermined and chemical-free response to the hydrates formation, the predetermined and chemical-free response further comprising:
subjecting the branch media pipeline to a valve opening and closing sequence; and
ensuring, using the valve opening and closing sequence, threshold pressure differences between the at least one choke prior to ceasing of a flow associated with the media through the branch media pipeline or together with starting up the at least one subsea reservoir, based at least in part on a system modelled and subject to a subsea injection system.

19. The method of claim 12, wherein the at least one choke is a series connection or a parallel connection of at least two chokes, wherein at least one of the at least two chokes is in the at least one mounting structure.

20. The method of claim 12, wherein the branch media pipeline is a heat exchanger to allow transfer of heat from a subsea environment to the media.
